(19) United States
(12) Patent Application Publication
(10) Pub. No.: US 2009/0116255 A1
(43) Pub. Date: May 7, 2009

(54) ROUND LAMPS WITH INTEGRATED HEADLINER ATTACHMENT

(75) Inventors: Benjamin James Kearns, Clarkston, MI (US); Jackqueline Marie Campbell, Lake Orion, MI (US); Andrew F. Raczkowski, Waterford, MI (US); Phillip Basil Bitsoli, Canton, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc, Dearborn, MI (US)

(21) Appl. No.: 11/934,778

(22) Filed: Nov. 4, 2007

(51) Int. Cl. B60Q 1/26

(52) U.S. Cl. 362/490

(57) ABSTRACT

A lamp assembly includes a bezel having a lamp receiving section and an integrated attachment section. The integrated attachment section has one or more outwardly directed extensions for attaching the lamp assembly to the interior component by rotating the bezel into a receiving aperture. A lamp housing is disposed within the lamp receiving assembly. Finally, the lamp assembly includes a light source positioned within the lamp housing for projecting light along a light path.

### BACKGROUND OF THE INVENTION

1. Field of the Invention

In at least one aspect, the present invention relates to vehicle interior lighting.

2. Background Art

The demand for aesthetically pleasing automobile interior accessories with enhanced functionality continues to grow. Consumers expect enhancement of basic features, such as interior lighting, as models change from year to year. Likewise, manufacturers are continually examining new materials, designs, and assembly procedures to meet the consumer demand while attempting to reduce complexity and cost.

Currently, lamp housing designs for vehicle interior lighting tend to be somewhat complex with a relatively large footprint. Complexity arises from the multi-component nature of the lamp assembly in which there is a separate component for attachment to the vehicle headliner. Such multi-component designs add expense by requiring an extra assembly step.

Accordingly, for at least these reasons, there is a need for new flexible vehicle interior components that are economical to fabricate and install.

### SUMMARY OF THE INVENTION

The present invention solves one or more problems of the prior art by providing in at least one aspect a lamp assembly for attachment to a vehicle interior component. The lamp assembly of this embodiment includes a bezel having a lamp receiving section and an integrated attachment section. The integrated attachment section has one or more outwardly directed extensions for attaching the lamp assembly to the interior component by rotating the bezel into a receiving aperture. A lamp housing is disposed within the lamp receiving assembly. Finally, the lamp assembly includes a light source positioned within the lamp housing for projecting light along a light path. Advantageously, the present embodiment provides lamp assemblies with small footprints. In particular, compact round lamp assemblies may be utilized if desired.

In another embodiment of the present invention, a vehicle lighting system in which the lamp assembly set forth above is attached to a headliner is provided.

### BRIEF DESCRIPTION OF THE DRAWINGS

FIG. 1 is an idealized schematic of an embodiment of a lamp assembly;

FIG. 2 is a side view of an embodiment of a lamp assembly;

FIG. 3 is a perspective view of an embodiment of a lamp assembly;

FIG. 4 is a top view of an embodiment of a lamp assembly;

FIG. 5 is a bottom view of an embodiment of a lamp assembly;

FIG. 6 provides a front view of an aperture in a headliner for receiving the lamp assembly of the invention; and

FIG. 7 provides a front view of a vehicle headliner.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

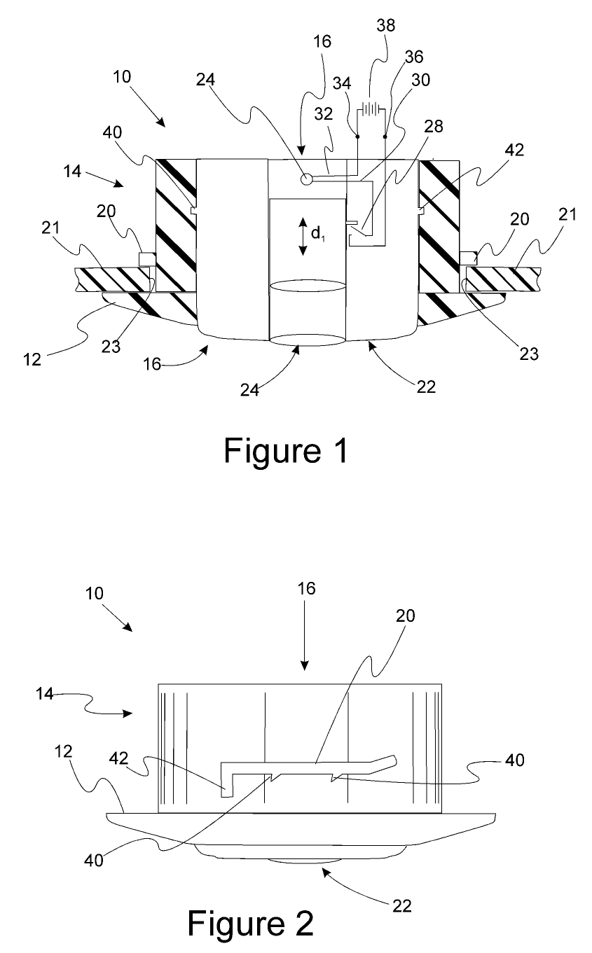

With reference to FIGS. 1 and 2, illustrations of an embodiment of a lamp assembly for attachment to a vehicle interior component are provided. FIG. 1 is an idealized schematic of the lamp assembly of the present embodiment. FIG. 2 is a side view of the lamp assembly. Lamp assembly 10 includes bezel 12. Bezel 12 includes lamp receiving section 14 and integrated attachment section 16. It should be appreciated, that integrated in this context means that bezel 12 is constructed so that lamp receiving section 14 and integrated attachment section 16 are continuous being formed in the same piece of material (i.e., they are monolithic). Integrated attachment section has one or more outwardly directed extensions 20 for attaching lamp assembly 10 to interior component 21. Lamp assembly 10 is attached to interior component 21 by rotation in receiving aperture 23 in interior component 21. Lamp housing 22 is positioned within lamp receiving assembly 14. In a refinement, lamp housing 22 has a circular configuration. Light source 24 is positioned within lamp housing 22. Useful designs for lamp housing 22 are set forth in U.S. Pat. Nos. 7,220,029 and 7,261,450, the entire disclosures of which are hereby incorporated by reference. Light source 24 provides visible light along a light path which is used to illuminate the interior of a vehicle. Light source 24 may be any light source that is capable of safely providing light to a vehicle interior. Examples of such light sources include, but are not limited to, incandescent light bulbs and light emitting diodes (“LED”). LED's are particularly useful because of their outstanding durability and low cost.

Still referring to FIGS. 1 and 2, in a variation of the present embodiment, lamp housing 22 further includes movable lens system 24 for focusing light at one or more positions. Lens system 24 is moveable along direction d₁ to allow such focusing. Lamp assembly 10 includes switch 28 for operating light source. Useful designs for lens system 24 and switch 28 are set forth in U.S. Pat. Nos. 7,220,029 and 7,261,450, the entire disclosures of which are hereby incorporated by reference. In a variation of the present embodiment, switch 28 is operable by movement of lens system 24 along direction d₁. Lamp assembly 10 includes electrical lines 30, 32 for operating light source 24. Electrical contacts 34, 36 assist in attachment of light source 24 to power supply 38 so that electrical contact with light source 24 is established. In one refinement power supply 38 is a vehicle battery. In another variation, power supply 38 is a battery that is sufficiently small enough to be included within or proximate to lamp assembly 10.

In another variation of the present embodiment, light source 24 is pivotally supported within the lamp housing. In one refinement, pivoting of light source 24 is accomplished by pivoting of lamp housing 22 about pivot points 40, 42. In another refinement, a component of lamp housing 22 is pivotable, thereby allowing redirection of light emerging from light source 24.

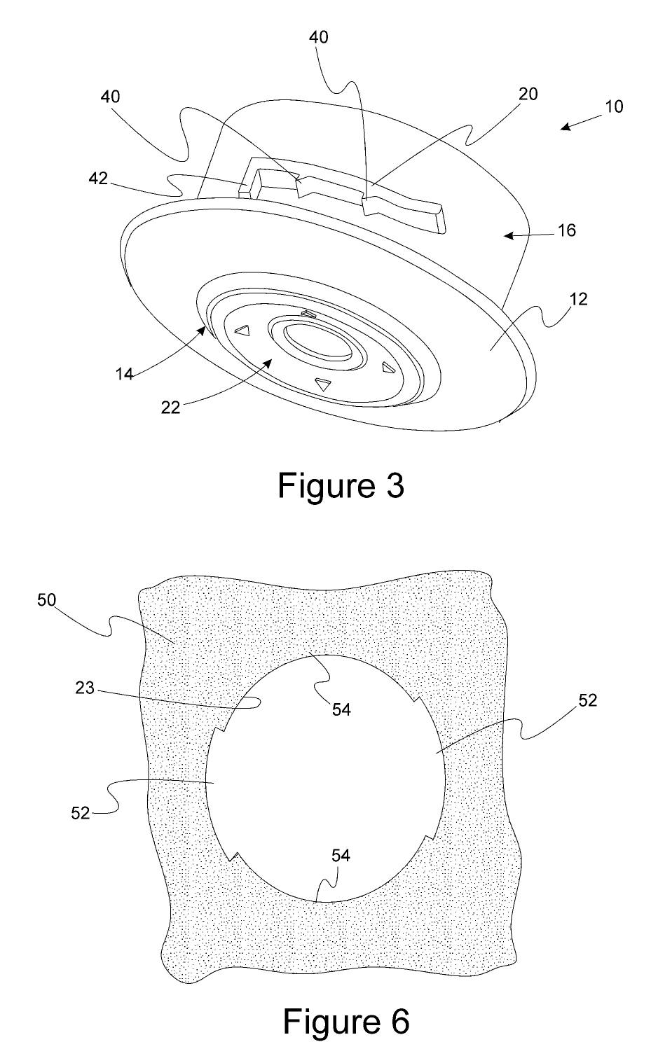

With reference to FIGS. 3, 4, and 5, various views of the lamp assembly 10 are provided. FIG. 3 provides a perspective view of lamp assembly 10. FIG. 4 provides a top view while FIG. 5 provides a bottom view of lamp assembly 10. As set forth above, integrated attachment section 16 includes one or more outwardly directed extensions 20. In a variation of the present embodiment, outwardly directed extensions 20 include one or more locking protrusions 40 for holding lamp assembly 10 to the interior component. Bezel 10 also includes stop(s) 42 for limiting rotation of the bezel relative to the receiving aperture.

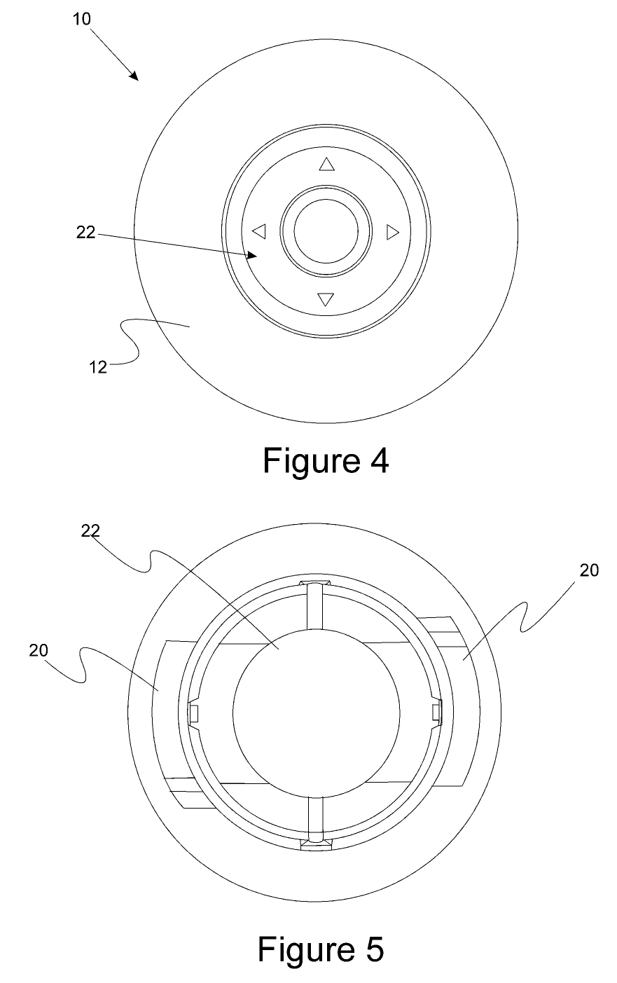

With reference to FIG. 6, a front view of a variation of aperture 23 is provided. Headliner 50 includes aperture 23 which includes regions 52 allowing passage of extensions 20 of bezel 12 through headliner 23. Lamp assembly 10 is then rotated about direction d₂ such that inward extensions 54 of headliner 50 align with outward extensions 30 of bezel 12 thereby securing lamp assembly 10 to the headliner.

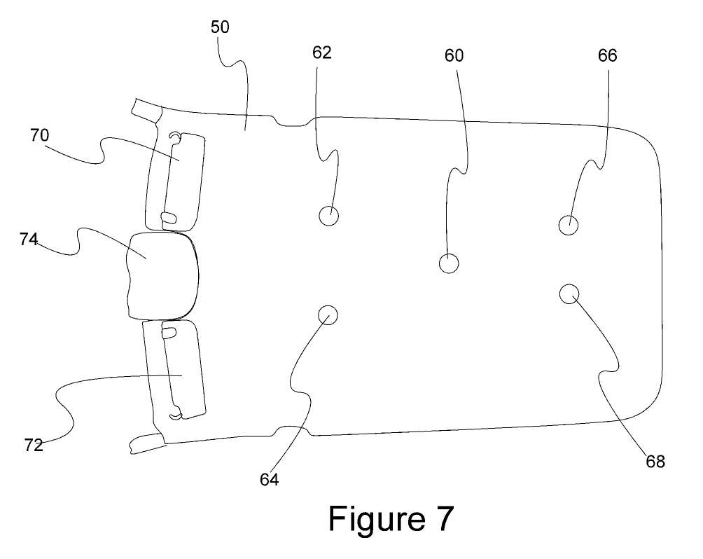

With reference to FIG. 7, a front view of a headliner positioned in a vehicle passenger compartment is provided. Advantageously, the compact design of the present invention allows incorporations of numerous lamp assemblies while having a minimal footprint. Headliner 50 includes center dome lamp 60 and vehicle occupant illumination lamps 62, 64, 66, 68. Each of lamps 60-68 are of the design of lamp assembly 10 set forth in detail above. Also depicted in FIG. 7 are sun visors 70, 72 and center console 74. In a variation of the present embodiment, each of lamps 60-68 have a round configuration.

One skilled in the art will recognize that bezel 12 can be made of virtually any material capable of being formed into the shape set forth above. Plastics are a useful material for the construction of bezel 12. Particularly useful plastics include thermoplastic resins and thermoset resins. Examples of thermoplastic resins, include but are not limited to, polyvinylchloride, polyethylene, polypropylene, other polyolefins, or nylon. Accordingly, the bezel of the present embodiment is advantageously made by injection modeling, compression molding, or by RIM. In the case of injection molding, urethanes are particularly useful.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A lamp assembly for attachment to a vehicle interior component, the lamp assembly comprising:
a bezel having a lamp receiving section and an integrated attachment section, the integrated attachment section having one or more outwardly directed extensions for attaching the lamp assembly to the interior component by rotating the bezel into a receiving aperture;
a lamp housing disposed within the lamp receiving assembly; and
a light source for projecting light along a light path, the light source positioned within the lamp housing.

2. The lamp assembly of claim 1 wherein the vehicle interior component is a vehicle headliner.

3. The lamp assembly of claim 1 wherein the outwardly directed extensions include one or more locking protrusions for holding the lamp assembly to the interior component.

4. The lamp assembly of claim 1 wherein the bezel further includes a stop for limiting rotation of the bezel relative to the receiving aperture.

5. The lamp assembly of claim 1 wherein the bezel comprises a plastic.

6. The lamp assembly of claim 4 wherein the plastic is a thermoplastic resin.

7. The lamp assembly of claim 1 wherein the light source is pivotally supported within the lamp housing.

8. The lamp assembly of claim 1 wherein the light source further includes a movable lens system for focusing light at one or more position.

9. The lamp assembly of claim 8 further comprising a switch for operating the light source.

10. The lamp assembly of claim 9 wherein the switch is operable by movement of the lens system.

11. The lamp assembly of claim 9 further comprising contacts for attachment of the light source to a power supply.

12. The lamp assembly of claim 1 further comprising a battery in electrical contact with the light source.

13. A bezel for integration into a vehicle interior lamp assembly, the bezel comprising:
a lamp receiving section for holding a lamp housing; and
an attachment section, the attachment section having one or more outwardly directed extensions for attaching the lamp assembly to an interior component by rotating the bezel into a receiving aperture in the interior component.

14. The bezel of claim 13 wherein the outwardly directed extensions include one or more locking protrusions for holding the lamp assembly to the interior component.

15. The bezel of claim 13 wherein the bezel further includes a stop for limiting rotation of the bezel relative to the receiving aperture.

16. The bezel of claim 13 wherein the bezel comprises a plastic.

17. The bezel of claim 16 wherein the plastic is a thermoplastic resin.

18. A vehicle lighting system comprising:
a headliner having an aperture for holding a lamp assembly;
a lamp assembly attached to the headliner, the lamp assembly comprising:
a bezel having a lamp receiving section an integrated attachment section, the integrated attachment section having one or more outwardly directed extensions for attaching the lamp assembly to the interior component by rotating the bezel into a receiving aperture;
a lamp housing disposed within the lamp receiving assembly; and
a light source for projecting light along a light path, the light source positioned within the lamp housing.

19. The lighting system of claim 1 wherein the outwardly directed extensions include one or more locking protrusions for holding the lamp assembly to the interior component and a stop for limiting rotation of the bezel relative to the receiving aperture.

20. The lighting system of claim 1 wherein the outwardly directed extensions include one or more locking protrusions for holding the lamp assembly to the interior component and a stop for limiting rotation of the bezel relative to the receiving aperture.
